(19) United States
(12) Patent Application Publication
(10) Pub. No.: US 2015/0161536 A1
(43) Pub. Date: Jun. 11, 2015

(54) SCIENTIFIC WORKFLOW EXECUTION ENGINE

(71) Applicant: BIODATOMICS, LLC, Bethesda, MD (US)

(72) Inventor: Maxim Mikheev, Elkridge, MD (US)

(73) Assignee: BIODATOMICS, LLC, Bethesda, MD (US)

(21) Appl. No.: 14/099,789

(22) Filed: Dec. 6, 2013

(51) Int. Cl. G06Q 10/06

(52) U.S. Cl. CPC G06Q 10/0633

(57) ABSTRACT

Provided are methods and systems for computer-implemented event-driven management of scientific workflows. An event-driven management engine for scientific workflows may comprise a decision node configured to determine that at least one condition within a scientific workflow is true by running a conditional loop. Based on the determination, the decision node may selectively activate a computational module. The event-driven management engine for scientific workflows may further comprise a fork-join queuing cluster. The fork-join queuing cluster may allocate the computational module non-sequentially to participant computational nodes in a distributed cloud computing environment and process a data set according to predetermined criteria. A distributed database of the event-driven management engine for scientific workflows may store the computational modules and conditions associated with the at least one computational module.

### TECHNICAL FIELD

This disclosure relates generally to data processing and, more specifically, to event-driven scientific workflow management.

### BACKGROUND

The approaches described in this section could be pursued but are not necessarily approaches that have previously been conceived or pursued. Therefore, unless otherwise indicated, it should not be assumed that any of the approaches described in this section qualify as prior art merely by virtue of their inclusion in this section.

A traditional workflow management system can manage and define a series of tasks within a project to produce a final result. Workflow management systems can allow defining different workflows for different types of tasks or processes. Furthermore, workflow management systems can assist a user in development of complex applications at a higher level by orchestrating functional components without handling the implementation details. For software-based workflow management systems, at each stage in the workflow, one or more executable software modules may be responsible for a specific task. Once the task is complete, the workflow software can ensure that the next task will be executed by the modules responsible for the next stage of the process. The workflow management system can reflect the dependencies required for the completion of each task. In general, the workflow management system can control automated processes by automating redundant tasks and ensuring that uncompleted tasks are followed up.

The workflow management system may be developed in a specialized form for specific needs. Specifically, a scientific workflow management system can be designed to compose and execute a series of computational and data processing operations for a scientific application. An example of a scientific workflow management system is a bioinformatics workflow management system. Bioinformatics can be defined as an interdisciplinary field that develops and improves on methods for storing, retrieving, organizing and analyzing biological data. A major activity in bioinformatics is developing software tools to generate useful biological knowledge. However, it should be understood that applications of the technology disclosed here are not necessarily limited to bioinformatics.

Since scientific workflows may differ from traditional business process workflows, the scientific workflow management system can enable scientists to perform specific steps. For example, interactive tools can be provided to enable scientists to execute scientific workflows and to view results interactively. Additionally, scientists may be enabled to track the source of the workflow execution results and the steps used to create the workflow.

Scientists are developing more and more complex workflows to manage and process large data sets and to execute scientific experiments. However, available workflow engines are restricted to specific types of applications and their adaptation for scientific purposes can be difficult. In addition, available workflow engines are usually configured as directed acyclic graphs. In a directed acyclic graph, each node represents a task to be executed and edges represent either data flow or execution dependencies between different tasks. Thus, sequences of data may only flow in a specific direction and may not allow for parallel execution of computational units.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

The present disclosure is related to approaches for computer-implemented event-driven management of scientific workflows. Specifically, an event-driven management engine for scientific workflows may comprise a decision node configured to determine that a condition is true by running a conditional loop. Based on the determination, the decision node may selectively activate a computational module. The event-driven management engine for scientific workflows may further comprise a fork-join queuing cluster. The fork-join queuing cluster may allocate the computational module non-sequentially to participant computational nodes and process a data set according to predetermined criteria. The participant computational nodes may be located in a distributed cloud computing environment. A distributed database of the event-driven management engine for scientific workflows may store the computational modules and conditions associated with the computational modules. A computation module may remain inactivated until the condition is true.

According to another approach of the present disclosure, there is provided a computer-implemented event-driven management method for scientific workflows. According to the method, a database may store computational modules and conditions associated with the computational modules. The method may comprise a decision node running a conditional loop to determine that the condition is true. Based on the determination, the decision node may selectively activate the computational module. The method may further comprise allocating, by a fork-join queuing cluster, the computational module non-sequentially to participant computational nodes in a distributed cloud computing environment. The computational module may be configured to process a data set according to predetermined criteria.

In further example embodiments of the present disclosure, the method steps are stored on a machine-readable medium comprising instructions, which when implemented by one or more processors perform the recited steps. In yet further example embodiments, hardware systems, or devices can be adapted to perform the recited steps. Other features, examples, and embodiments are described below.

### BRIEF DESCRIPTION OF THE DRAWINGS

Embodiments are illustrated by way of example, and not by limitation, in the figures of the accompanying drawings, in which like references indicate similar elements and in which:

FIG. 1 shows an environment within which an event-driven management engine for scientific workflows and corresponding methods can be implemented, according to an example embodiment.

FIG. 2 is a block diagram showing various modules of an event-driven management engine for scientific workflows, according to an example embodiment.

FIG. 3 is a block diagram illustrating processing of a task by an event-driven management engine for scientific workflows, according to an example embodiment.

FIG. 4 is a block diagram illustrating processing of a task by a fork-join queuing cluster, according to an example embodiment.

FIG. 5 is a block diagram illustrating processing of a task by a fork-join queuing cluster, according to an example embodiment.

FIG. 6 is a process flow diagram showing an event-driven management method for scientific workflows, according to an example embodiment.

FIG. 7 is a flow chart illustrating a detailed computer-implemented event-driven management method for scientific workflows, according to an example embodiment.

FIG. 8 is a flow chart illustrating a method for checking a condition, according to an example embodiment.

FIG. 9 is flow chart illustrating a conditional loop, according to an example embodiment.

FIG. 10 is a flow chart illustrating a conditional loop, according to an example embodiment.

FIG. 11 shows a diagrammatic representation of a computing device for a machine in the example electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is therefore not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein may be implemented using a variety of technologies. For example, the methods described herein may be implemented in software executing on a computer system or in hardware utilizing either a combination of microprocessors or other specially designed application-specific integrated circuits (ASICs), programmable logic devices, or various combinations thereof. In particular, the methods described herein may be implemented by a series of computer-executable instructions residing on a storage medium, such as a disk drive, or a computer-readable medium. It should be noted that methods disclosed herein can be implemented by a mobile terminal, a smart phone, a computer (e.g., a desktop computer, a tablet computer, a laptop computer), and so forth.

The present disclosure relates to systems and methods for generating and implementing automated workflow activities. Specifically, embodiments described herein include an event-driven management engine for scientific workflows and method. Conventional workflow engines create a process for each workflow that can determine a current state of the workflow and a next step to be executed. In other words, such workflow engines may need to permanently trace the current state of the workflow and make decisions as to what action should be taken next. Furthermore, the conventional workflow system may need control points to save the current state of the workflow in order to ensure a successful restart of the workflow in case of a failure. The event-driven management engine enables scientists in the fields of science such as, for example, biology, bionomics, and bioinformatics, to query and analyze sequence data using a number of informatics tools and save the results.

As outlined in the summary, the embodiments of the present disclosure are directed to event-driven management for scientific workflows. An event-driven scientific workflow may be determined by events occurring in the workflow, such as a user action, a sensor output, notifications from other programs, and so forth. The disclosed technology may allow defining conditions associated with each event occurring in the workflow and storing the conditions in a database. Furthermore, the database may store steps and associated tasks to be performed upon satisfaction of the condition. Therefore, when the event occurs, the engine may read the database to confirm that the conditions associated with the event are satisfied and run a corresponding process to execute the task associated with the condition.

Specifically, a decision node may run a conditional loop that may check whether the condition is satisfied. Once the condition is satisfied, the decision node may activate the computational node responsible for processing the satisfied condition and execute the corresponding part of the workflow. Computational nodes responsible for processing may run only after the conditions are satisfied. Until the conditions are satisfied, the computational nodes may be in a waiting mode (i.e., inactivated).

It should be noted that in the case of an unexpected shutdown, the workflow may be easily restored by running conditional loops and determining which conditions are satisfied. After determining which conditions are satisfied, the tasks associated with the satisfied conditions may be restarted. Thus, there is no need to save control points to restart the workflow.

Furthermore, the present technology may be used in scientific workflow systems, such as bioinformatics workflow management systems, to manage computations performed on biological data, which are computationally intensive. To improve the efficiency, the present technology may involve data processing in a parallel-distributed software framework. The parallel-distributed software framework may support computationally-intensive distributed tasks by running tasks on a number of computational clusters in parallel. The present technology may utilize fork-queuing nodes to split tasks between multiple computational clusters. Furthermore, the fork-queuing nodes may be configured to divide a task associated with the event into multiple task fragments, each of which can be executed in parallel with other fragments on any node of the cluster. The fork-queuing cluster may select the nodes for execution of these task fragments. The nodes may include cloud-based computational clusters. After execution of the fragments by the nodes, the fork-queuing cluster may join the executed fragments into resulting data.

The resulting data may be shown to a user on a user interface. The user may choose the way in which the processed data may be represented. For example, the processed data may be shown as data tables, diagrams, text, graphs, drawings, and so forth.

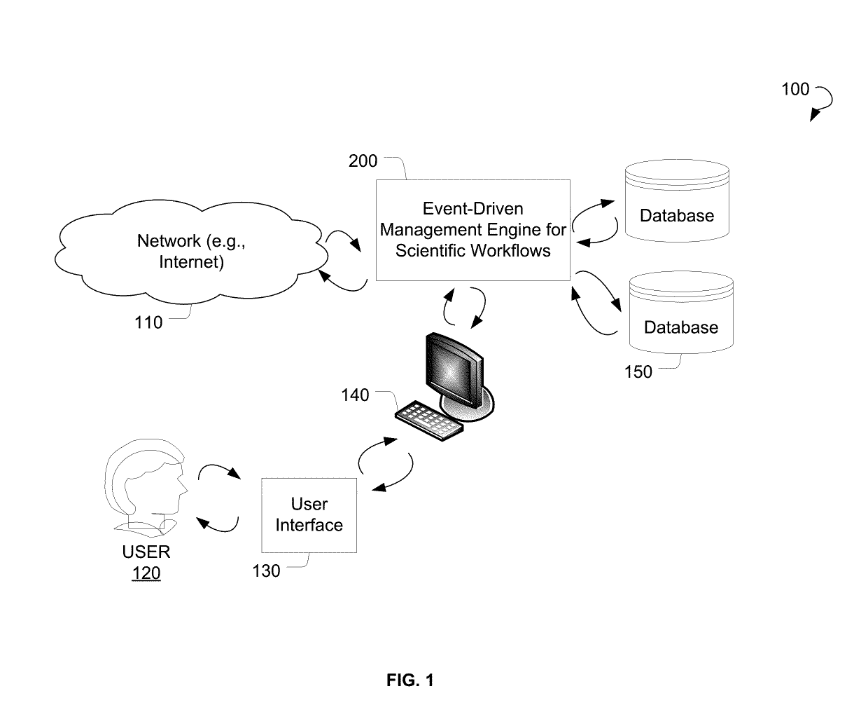

Referring now to the drawings, FIG. 1 illustrates an environment 100 within which an event-driven management engine for scientific workflows and method can be implemented. The environment 100 may include a network 110, a user 120, an event-driven management engine 200 for scientific workflows, a user interface 130, one or more client devices 140, and a database 150.

The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may include a network of data processing nodes that are interconnected for the purpose of data communication. The network 110 may include a Software-defined Networking (SDN). The SDN may include one or more of the above network types. Generally the network 110 may include a number of similar or dissimilar devices connected together by a transport medium enabling communication between the devices by using a predefined protocol. Those skilled in the art will recognize that the present disclosure may be practiced within a variety of network configuration environments and on a variety of computing devices.

The client device 140, in some example embodiments, may include a Graphical User Interface (GUI) for displaying the user interface 130. In a typical GUI, instead of offering only text menus or requiring typed commands, the engine 200 may present graphical icons, visual indicators, or special graphical elements called widgets. The user interface 130 may be utilized as a visual front-end to allow the user 120 to build and modify complex tasks with little or no programming expertise.

The client device 140 may include a mobile telephone, a computer, a lap top, a smart phone, a tablet Personal Computer (PC), and so forth. In some embodiments, the client device 140 may be associated with one or more users 120. The client device 140 may be configured to utilize icons used in conjunction with text, labels, or text navigation to fully represent the information and actions available to the user 120. The user 120, in some example embodiments, may be a person interacting with the user interface 130 via one of the client devices 140. The user 120 may represent a person that uses the event-driven management engine 200 for scientific workflows for his or her needs. For example, the user 120 may include a scientist using the event-driven management engine 200 for scientific workflows for performing a series of computational or data manipulation steps. As shown on FIG. 1, the user 120 may input data to an application running on the client device 140. The application may utilize the event-driven management engine 200 for scientific workflows. Based on the input of the user 120, the event-driven management engine 200 for scientific workflows may generate and execute the automated workflow of the application running on the client device 140. The event-driven management engine 200 for scientific workflows may be connected to one or more databases 150. The databases 150 may store data associated with tasks that need to be executed in the course of the workflow.

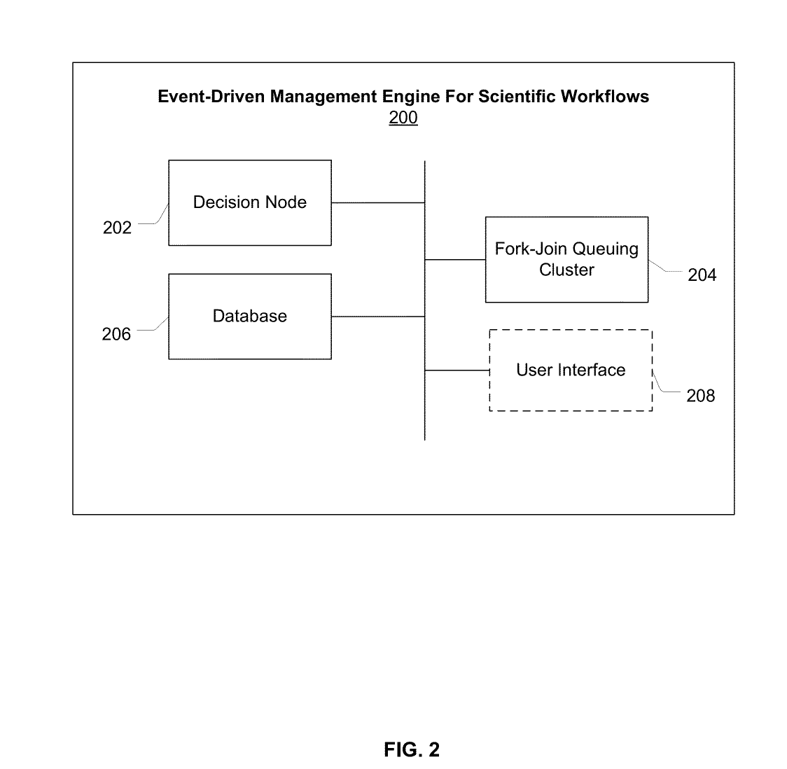

FIG. 2 shows a detailed block diagram of the event-driven management engine 200 for scientific workflows, in accordance with an example embodiment. The engine 200 may include a decision node 202, a fork-join queuing cluster 204, a database 206, and, optionally, a user interface 208.

The user may run an application that may utilize the event-driven management engine 200 for scientific workflows. During running of the application, an event may occur. The event may include a user action, a sensor output, a notification from other programs, and so forth. Each event may be associated with one or more conditions that may be stored in the event-driven management engine 200 for scientific workflows. The management engine 200 for scientific workflows may include a decision node 202, a fork-join queuing cluster 204, a database 206, and, optionally, a user interface 208.

In an example embodiment, the decision node 202 may be configured to determine that the at least one condition is true. The determination that the at least one condition is true may be performed by running a conditional loop. The conditional loop may be configured to check whether the at least one condition is true.

The decision node 202 may be further configured to selectively activate, based on the determination, at least one computational module. The computational module may include a computational tool. The workflow may support a plurality of biological data formats and translations between the plurality of biological data formats. Therefore, the computational tool may refer to a specific field of science (for example, bioinformatics). In this case, the computational tool may include a bioinformatics tool enabling the user to process specific bioinformatics tasks.

After activation of the computational module, the fork-join queuing cluster 204 may allocate at least one computational module non-sequentially to participant computational nodes. The participant computational nodes may be located in a distributed cloud computing environment. By means of the participant computational nodes, the fork-join queuing cluster 204 may process a data set according to predetermined criteria.

The distributed database 206 may be configured to store at least one computational module. Furthermore, the distributed database 206 may be configured to store at least one condition associated with the at least one computational module. The user interface 208 may allow a user to build computational modules, modify computational modules, specify data sources, specify conditions for execution of the computational modules, etc.

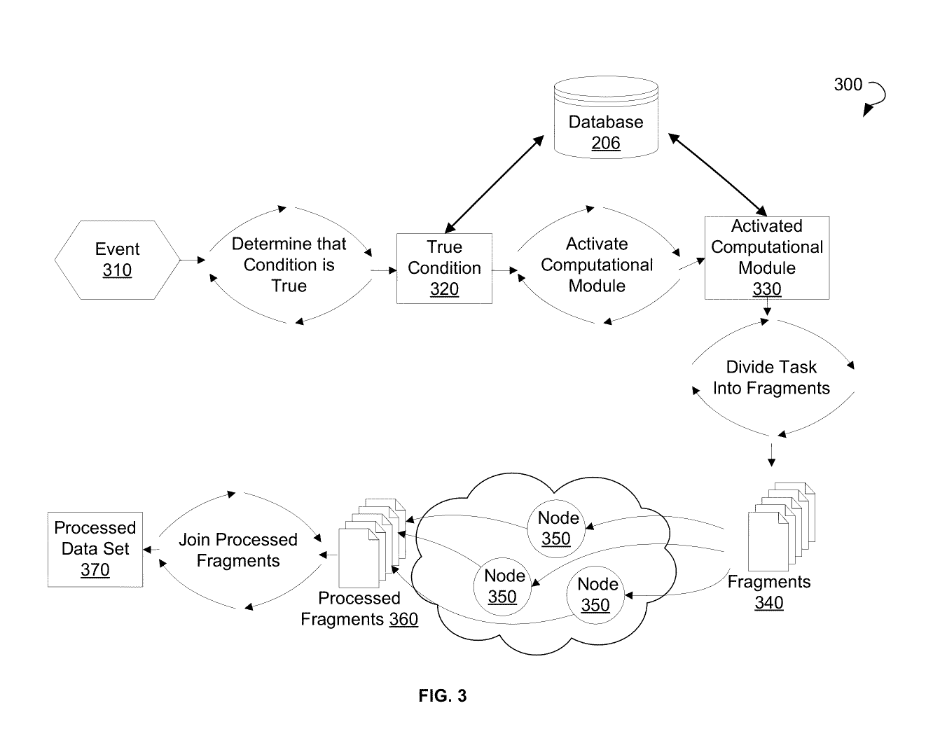

The engine 200 is further described in detail with reference to FIG. 3. FIG. 3 shows a graphical representation 300 for managing the workflow using the engine 200. Each event occurring in the workflow may be associated with one or more conditions. In other words, a condition may be satisfied when the event associated with this condition occurs. A decision node of the event-driven management engine for scientific workflows may run a conditional loop in order to check whether the at least one condition is true. Upon occurring of an event 310, the decision node may determine that the at least one condition is true. Each true condition 320 associated with the event 310 may run a task. A task may include processing a data set, such as performing computations, sorting data, drawing diagrams, and so forth. In an example embodiment, the data set may be selected by the user (e.g., from a database). Furthermore, the data set may be obtained from testing equipment. The user may use the user interface to specify data sources from which the data set may be obtained.

After the determination that there is a true condition 320, the decision node may selectively activate at least one computational module. The computational modules and the condition associated with the computational modules may be stored in a database 206. In an example embodiment, the user may use a user interface to build or modify the computational modules, as well as specify conditions for execution of the computational modules.

Once there is at least one activated computational module 330, a fork-join queuing cluster of the event-driven management engine for scientific workflows may allocate at least one computational module non-sequentially to participant computational nodes in a distributed cloud computing environment. The cloud computing environment may include a plurality of computational clusters to increase performance and enable parallel execution of the tasks. Furthermore, the fork-join queuing cluster may process a data set according to predetermined criteria.

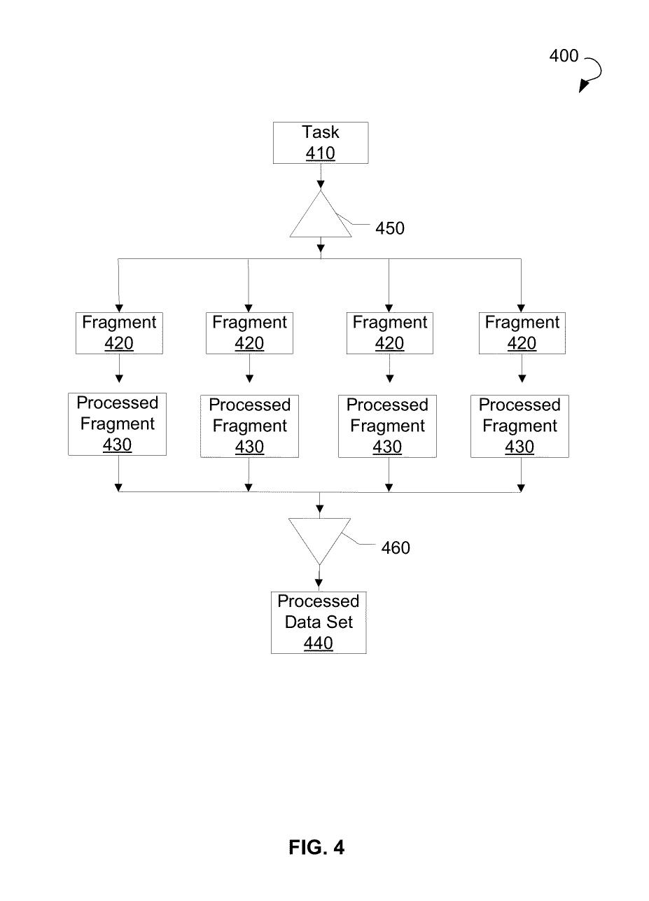

The parallel steps performed by the fork-join queuing cluster are illustrated in detail on a scheme 400 of FIG. 4. Conventional workflow execution engines support only predefined splits and cannot handle dynamic splits that depend on specific parameters. In the disclosed technology, if a number of parallel tasks is being performed, the fork-join queuing cluster can split, at a fork point 450, incoming task 410 into a number of sub-tasks represented as fragments 420. The splits can be determined when the fork-join queuing cluster starts splitting tasks. The fragments 420 can be processed by numerous computational nodes (not shown). After processing of the fragments 420, the processed fragments 430 may be joined at a join point 460 into a processed data set 440. It should be noted that splitting steps need to be finalized before the joining step.

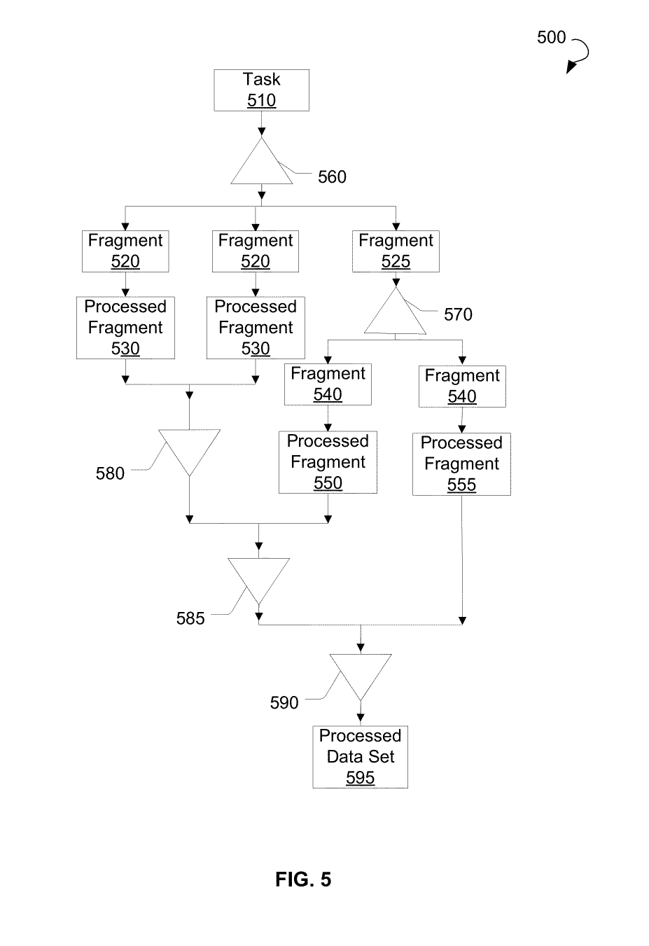

FIG. 5 shows a flow chart 500 for performing asymmetric splitting and joining by the fork-join queuing cluster. Conventional workflow execution engines require pairs of fork and join points. In the disclosed technology, fork points do necessarily have corresponding join points. Thus, the fork-join queuing cluster shown in FIG. 5 has two fork points and three join points. Fork points and join points may be located anywhere in the workflow. In fact, any tool that allows input from multiple sources can serve as a join point. If the join point has an input from several fork points, the join point can join the fragments when results from all fork points are available.

As shown on FIG. 5, the fork-join queuing cluster may split, at a fork point 560, an incoming task 510 into a number of sub-tasks represented as fragments 520, 525. The fragments 520 can be processed by numerous computational nodes (not shown). After processing of the fragments 520, the processed fragments 530 can be joined at a join point 580.

The fragment 525 can still be too complex for processing by a single computational node. Therefore, the fragment 525 may be split, at a fork point 570, into a number of fragments 540. The fragments 540 may be processed by the computational nodes. After processing of the fragments 540, some of the processed fragments, in particular the processed fragments 550, can be joined, at a join point 585, with the processed fragments joined at the join point 580. Another portion of the processed fragments, in particular the processed fragments 555, can be joined, at a join point 590, with the processed fragments joined at the join point 585. After joining at the join point 590, a processed data set 595 can be obtained.

Referring again to FIG. 3, the fork-join queuing cluster may include a master node and participant computational nodes. The master node may be configured to receive tasks associated with the computational module, divide the tasks into a plurality of fragments, and distribute fragments to participant computational nodes. The participant computational nodes may be configured to process the fragments and send processed fragments to the master node.

Specifically, allocation of the computational module to the participant computational nodes may be performed by dividing tasks associated with the computational module into a plurality of fragments 340. Each fragment 340 may be processed on a participant computational node 350. The computational module may be configured to use one or more fork-join queuing clusters configured to divide the tasks for service by the participant computational nodes 350. The participant computational nodes 350 may process the fragments 340 to obtain processed fragments 360. After processing by the participant computational nodes 350, the master node may collect the processed fragments 360 from the participant computational nodes 350 and join the processed fragments 360 into a processed data set 370. The processed data set 370 may be provided to the user by a user interface.

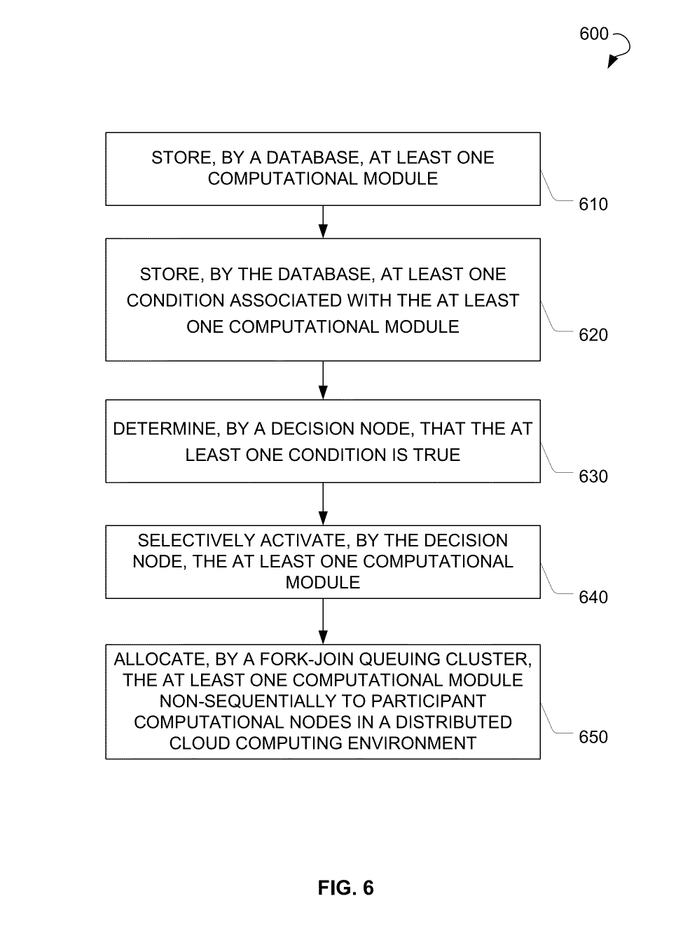

FIG. 6 is a process flow diagram showing a computer-implemented event-driven management method 600 for scientific workflows, according to an example embodiment. The method 600 may be performed by processing logic that may comprise hardware (e.g., decision making logic, dedicated logic, programmable logic, and microcode), software (such as software running on a general-purpose computer system or a dedicated machine), or a combination of both.

The method 600 may commence with storing, by a distributed database, at least one computational module at operation 610. At operation 620, the method may comprise storing, by the distributed database, at least one condition associated with the computational module. The computation module may be not activated until the at least one condition is true.

At operation 630, a decision node may determine that the at least one condition is true by running a conditional loop configured to check whether the at least one condition is true. Based on the determination, the decision node may selectively activate the at least one computational module at operation 640.

After the computational module is activated, at operation 650, a fork-join queuing cluster may allocate the computational module non-sequentially to participant computational nodes in a distributed cloud computing environment. The cloud computing environment may include a plurality of computational clusters to increase performance and enable parallel execution of the tasks. The workflow may support a plurality of biological data formats and translations between the plurality of biological data formats. In view of this, in an example embodiment, the computational module may comprise a bioinformatics tool.

The computational module may be configured to process a data set according to predetermined criteria. In an example embodiment, the computational module may be allocated to the participant computational nodes by dividing tasks associated with the computational module into a plurality of fragments. Each fragment may be processed on a participant computational node. The processed fragments may be joined into a processed data set.

Specifically, the computational module may use one or more fork-join queuing clusters configured to divide the tasks for processing by the participant computational nodes. The fork-join queuing clusters may join processed fragments after processing by the participant computational nodes. In particular, each of the fork-join queuing clusters may include a master node and participant computational nodes. The master node may be configured to receive tasks associated with the computational module, divide the tasks into a plurality of fragments, and distribute fragments to participant computational nodes. The participant computational nodes may be configured to process the fragments and send processed fragments to the master node. The master node may collect the processed fragments from the participant computational nodes and join the processed fragments into a processed data set.

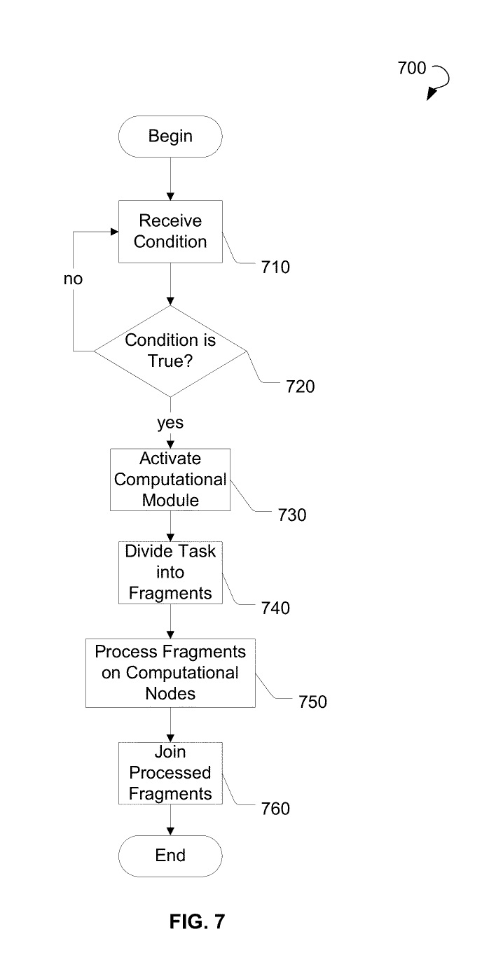

In more detail, the method 600 logics are illustrated on FIG. 7. FIG. 7 shows a flow chart illustrating a detailed computer-implemented event-driven management method 700 for scientific workflows, in accordance with some embodiments. As shown in FIG. 7, the method 700 may commence at operation 710 with receiving, by a decision node, a condition associated with an event occurring during in the workflow.

At operation 720, the decision node may run a conditional loop to check whether the received condition is true. If the condition is not true, the decision node may run a further conditional loop at operation 710 to check further conditions. If the condition is true, the condition may process a task associated with the event. For this purpose, the decision node may activate a computational module at operation 730. The computational module may be configured to process a data set associated with the task according to predetermined criteria.

After activation of the computational module, a fork-join queuing cluster may divide the task into a number of fragments at operation 740. The computational nodes of the fork-join queuing cluster may process the fragments at operation 750. After processing, the fork-join queuing cluster may join the processed fragments into a processed data set at operation 760. Optionally, the processed data set may be represented to a user on a user interface.

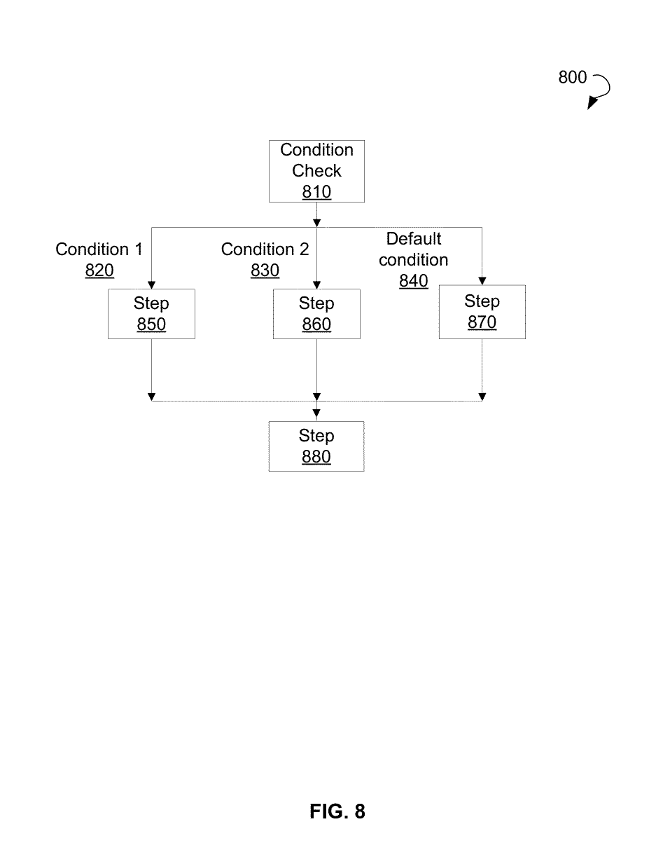

FIG. 8 is a flow chart 800 illustrating method 800 for checking a condition. During a condition check 810, it is determined which of conditions 820, 830, 840 are satisfied. If conditions 820, 830 are satisfied, the decision node performs corresponding steps 850 or 860. If none of the conditions 820, 830 is satisfied, the decision node selects a default condition 840 and performs step 870. When the condition check is finalized, step 800 is executed.

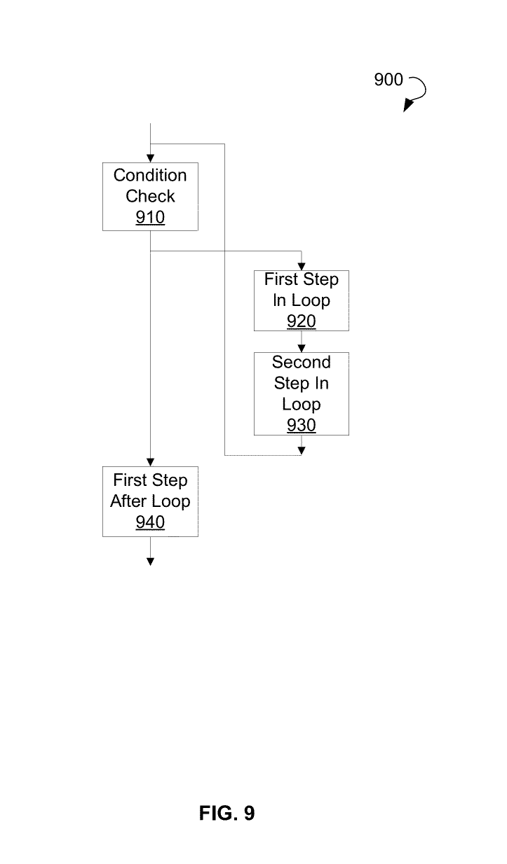

The conditional loop of step 720 in FIG. 7 is illustrated in more detail in FIG. 9 as a conditional loop 900. A condition check 910 is performed before the conditional loop 900 is executed. If, during the condition check 910, it is determined that the condition is false, all loop steps are added to the database. After adding the loop steps to the database, the loop steps shown as a first step in the loop 920 and a second step in the loop 930 are executed. If the condition is true, the conditional loop 900 terminates and all steps subsequent to the conditional loop 900 are added to the database. After the steps are added to the database, step 940 is executed. If the condition is true for the first check, none of the loop steps are executed.

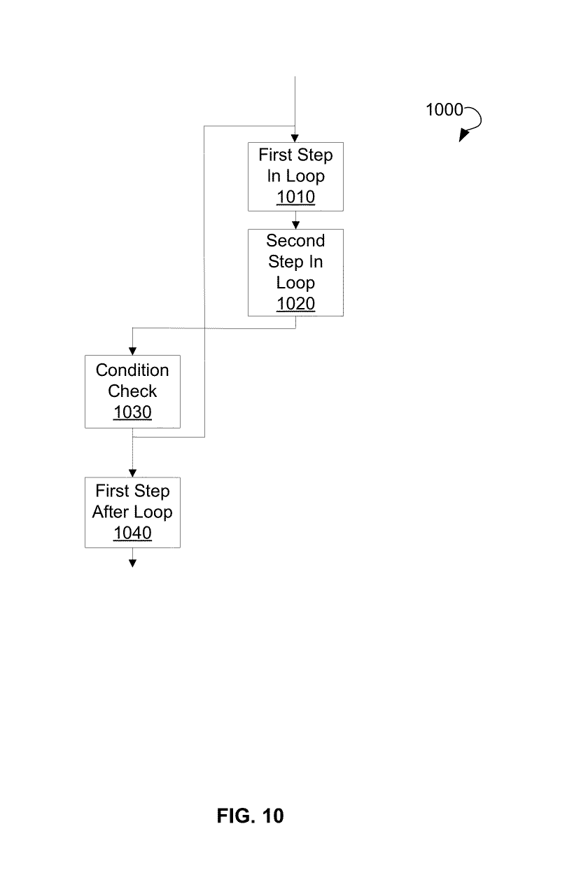

FIG. 10 illustrates another example conditional loop 1000. The loop 1000 is executed at least once before the condition check 1030. During execution of the conditional loop 1000, several steps can be performed, shown as a first step 1010 in the loop and a second step 1020 in the loop. If the condition is false, the conditional loop 1000 is executed again. The steps 1010 and 1020 of the conditional loop 1000 can be added to the database.

If the condition is true, the conditional loop 1000 terminates. All steps after the conditional loop 1000 are added to the database. After adding the steps to database, the first step 1040 is executed.

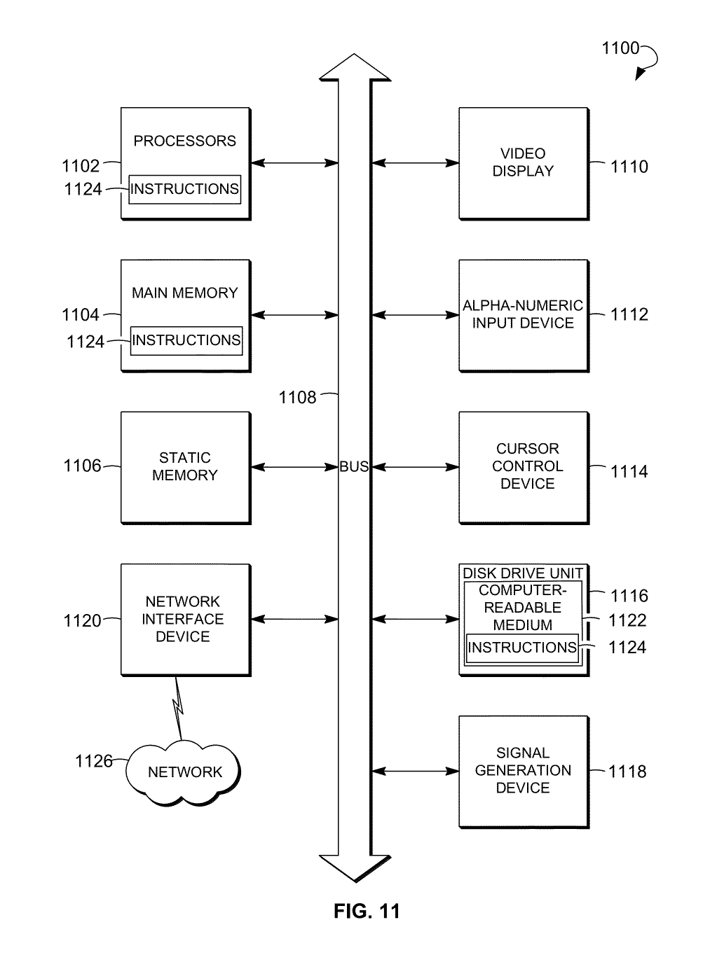

FIG. 11 shows a diagrammatic representation of a machine in the example electronic form of a computer system 700, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor or multiple processors 1102 (e.g., a central processing unit (CPU), a graphics processing unit (GPU), or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 may also include an alphanumeric input device 1112 (e.g., a keyboard), a cursor control device 1114 (e.g., a mouse), a disk drive unit 1116, a signal generation device 1118 (e.g., a speaker), and a network interface device 1120.

The disk drive unit 1116 includes a non-transitory computer-readable medium 1122, on which is stored one or more sets of instructions and data structures (e.g., instructions 1124) embodying or utilized by any one or more of the methodologies or functions described herein. The instructions 1124 may also reside, completely or at least partially, within the main memory 1104 and/or within the processors 1102 during execution thereof by the computer system 1100. The main memory 1104 and the processors 1102 may also constitute machine-readable media.

The instructions 1124 may further be transmitted or received over a network 1126 via the network interface device 1120 utilizing any one of a number of well-known transfer protocols (e.g., Hyper Text Transfer Protocol (HTTP)).

While the computer-readable medium 1122 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for event-driven management for scientific workflows are disclosed. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense.

What is claimed is:

1. An event-driven management engine for scientific workflows comprising:
a decision node configured to:
determine that at least one condition is true, wherein the determination that the at least one condition is true comprises running a conditional loop configured to check whether the at least one condition is true; and
based on the determination, selectively activate at least one computational module;
a fork-join queuing cluster configured to:
allocate the at least one computational module non-sequentially to participant computational nodes in a distributed cloud computing environment; and
process a data set according to predetermined criteria; and
a distributed database configured to:
store the at least one computational module; and
store the at least one condition associated with the at least one computational module, wherein the at least one computation module is not activated until the at least one condition is true.

2. The engine of claim 1, wherein the allocating of the at least one computational module non-sequentially to participant computational nodes comprises dividing tasks associated with the computational module into a plurality of fragments, each fragment being processed on a participant computational node.

3. The engine of claim 2, wherein the at least one computational module is configured to use one or more fork-join queuing clusters configured to divide the tasks for service by the participant computational nodes and join processed fragments after processing by the participant computational nodes.

4. The engine of claim 1, wherein the allocating of the at least one computational module non-sequentially to the participant computational nodes comprises joining processed fragments into a processed data set.

5. The engine of claim 1, wherein the fork-join queuing cluster includes a master node and participant computational nodes, wherein the master node is configured to receive tasks associated with the computational module, divide the tasks into a plurality of fragments, and distribute fragments to participant computational nodes; and
wherein the participant computational nodes are configured to process the fragments and send processed fragments to the master node.

6. The engine of claim 5, wherein the master node is further configured to collect the processed fragments from the participant computational nodes and join the processed fragments into a processed data set.

7. The engine of claim 1, where the cloud computing environment includes a plurality of computational clusters to increase performance and enable parallel execution of tasks.

8. The engine of claim 1, wherein the computational module comprises a bioinformatics tool.

9. The engine of claim 1, further comprising:
a user interface to allow a user to build computational modules, modify computational modules, specify data sources, and specify conditions for execution of the computational modules.

10. The engine of claim 1, wherein the workflow supports a plurality of biological data formats and translations between the plurality of biological data formats.

11. A computer-implemented event-driven management method for scientific workflows comprising:
storing, by a distributed database, at least one computational module;
storing, by the distributed database, at least one condition associated with the at least one computational module, wherein the at least one computation module is not activated until the at least one condition is true;
determining, by a decision node, that the at least one condition is true, wherein the determination that the at least one condition is true comprises running a conditional loop configured to check whether the at least one condition is true;
based on the determination, selectively activating, by the decision node, the at least one computational module; and
allocating, by a fork-join queuing cluster, the at least one computational module non-sequentially to participant computational nodes in a distributed cloud computing environment, wherein the at least one computational module is configured to process a data set according to predetermined criteria.

12. The method of claim 11, wherein the allocating of the at least one computational module non-sequentially to the participant computational nodes comprises dividing tasks associated with the computational module into a plurality of fragments, each fragment being processed on a participant computational node.

13. The method of claim 12, wherein the computational module is configured to use one or more fork-join queuing clusters configured to divide the tasks for service by the participant computational nodes and join processed fragments after processing by the participant computational nodes.

14. The method of claim 13, wherein each of the one or more fork-join queuing clusters includes a master node and participant computational nodes, wherein the master node is configured to receive tasks associated with the computational module, divide the tasks into a plurality of fragments, and distribute fragments to participant computational nodes; and
wherein the participant computational nodes are configured to process the fragments and send processed fragments to the master node.

15. The method of claim 11, wherein the allocating of the at least one computational module non-sequentially to the participant computational nodes comprises joining processed fragments into a processed data set.

16. The method of claim 11, where the cloud computing environment includes a plurality of computational clusters to increase performance and enable parallel execution of the tasks.

17. The method of claim 11, wherein the computational module comprises a bioinformatics tool.

18. The method of claim 11, further comprising providing a user interface to allow a user to build computational modules, modify computational modules, specify data sources, and specify conditions for execution of the computational modules.

19. The method of claim 11, wherein the workflow supports a plurality of biological data formats and translations between the plurality of biological data formats.

20. A non-transitory computer-readable medium comprising instructions, which when executed by one or more processors, perform the following operations:
store, by a distributed database, at least one computational module;
store, by the distributed database, at least one condition associated with the at least one computational module, wherein the at least one computation module is not activated until the at least one condition is true;
determine, by a decision node, that the at least one condition is true, wherein the determination that the at least one condition is true comprises running a conditional loop configured to check whether the at least one condition is true;
based on the determination, selectively activate, by the decision node, the at least one computational module; and
allocate, by a fork-join queuing cluster, the at least one computational module non-sequentially to participant computational nodes in a distributed cloud computing environment, wherein the at least one computational module is configured to process a data set according to predetermined criteria.
